(19) United States
(12) Patent Application Publication
(10) Pub. No.: US 2019/0095115 A1
(43) Pub. Date: Mar. 28, 2019

(54) METHOD OF MANAGING INTEGRATED CIRCUITS CARDS, CORRESPONDING CARD AND APPARATUS

(71) Applicant: STMicroelectronics S.r.l., Agrate Brianza (IT)

(72) Inventors: Maria Chichierchia, Castel Campagnano (IT); Vitantonio Di Stasio, Caserta (IT)

(21) Appl. No.: 16/126,252

(22) Filed: Sep. 10, 2018

(30) Foreign Application Priority Data
Sep. 22, 2017 (IT) 102017000106423

(51) Int. Cl. G06F 3/06

(52) U.S. Cl. CPC G06F 3/0632; G06F 3/0604; H04B 1/3816; G06F 3/0673; G06F 3/0659

(57) ABSTRACT

A file update message received in an integrated circuit card in a mobile communication apparatus having apparatus memory causes the card content to be updated in compliance with the file update message. An apparatus memory refresh command issued from the card causes the apparatus memory to align automatically with the updated card content.

### CROSS-REFERENCE TO RELATED APPLICATIONS

This application claims priority to Italian Patent Application No. 102017000106423, filed on Sep. 22, 2017, which application is hereby incorporated herein by reference.

### TECHNICAL FIELD

The description relates to integrated circuit cards.

One or more embodiments may be applied e.g. to Universal Integrated Circuit Cards (UICC's) for use e.g. in mobile communication equipment.

### BACKGROUND

Mobile communication equipment in e.g. Global System for Mobile communication (GSM) and Universal Mobile Telecommunications System (UMTS) networks may employ smart cards of the type currently referred to as Universal Integrated Circuit Card (UICC).

A UICC equipped with an operating system, applications, electrical profile may use a SIM application running on top of UICC operating system to gain access from a GSM network and a USIM application to gain access from a UMTS network. A UICC may contain several applications, making it possible for a same smart card to give access to several networks by also providing facilities to the users.

A network operator may generally require from SIM/UICC manufacturers a set of applets, security domains, and files that the smart card issuer stores in the smart card. This set of information is currently referred to as “operator profile.”

A recent development of UICC's is represented by embedded UICC (eUICC's) which may be incorporated, e.g., in a mobile terminal, thus enabling a user to change operator (and so its profile) over the air by means of a software procedure. An eUICC is also capable of managing multiple mobile network operator subscriptions, by making it possible for a user to enable/disable a current profile on the fly.

UICC and eUICC products do not represent static products insofar as they may be updated directly “on the field” by a mobile network operator in a silent mode, e. g., by using an over-the-air (OTA) protocol, so that the final user and the apparatus may not be aware of upgrades performed.

For instance, apparatus (e.g., user equipment such as a handset in a mobile communication network) where a SIM/USIM/(e)UICC card is inserted may load in its own memory during a boot phase the card profile in order to be able to manage network attach/detach, location update procedures, PLMN selection and so on by using data stored in such profile.

When an over-the-air binary message addressed to the UICC leads to one or more file updates, correct operation of the associated apparatus is facilitated by proper alignment of the card and the apparatus with the UICC image stored in the mobile memory updated correspondingly.

Mis-alignment of the actual UICC/eUICC content with respect to the one stored in the memory of the associated apparatus may result in unsatisfactory operation e.g. due to a delay between the time the file update operation is performed and the time the update is available for the user equipment. Also, the user may undesirably receive text asking him or her to turn the equipment off and then on again.

### SUMMARY

One or more embodiments contribute in providing improved solutions over the scenario discussed in the foregoing.

According to one or more embodiments, that may be achieved by means of a method having the features set forth in the claims that follow.

One or more embodiments may relate to a corresponding card and to a corresponding apparatus.

One or more embodiments may provide for automatic notification to the apparatus where the SIM/UICC/eUICC is inserted after a remote update operation of files stored in the SIM/UICC/eUICC.

One or more embodiments may provide a mechanism at the UICC/eUICC operating system level to trigger refresh of the associated apparatus after a file update by an over-the-air message.

One or more embodiments may provide one or more of the following advantages: improvement of refresh management by avoiding the application level; reduction of at least one nesting level makes the operational phase faster; less complexity to be managed due to the possibility of avoiding to design and manage an application; and over-the-air traffic reduced in comparison with conventional options.

One or more embodiments may involve moving operations from the application level to the operating system (OS) level.

One or more embodiments may be implemented by using a set of functions/mechanisms already standardized at the ETSI/3GPP level.

### BRIEF DESCRIPTION OF THE DRAWINGS

One or more embodiments will now be described, by way of example only, with reference to the annexed figures of drawing, wherein:

FIG. 1 is exemplary of apparatus adapted to include embodiments of the present invention;

FIG. 2 is exemplary of a possible sequence associated to an over-the-air binary message performing one or more file updates, for example, in the apparatus of FIG. 1;

FIG. 3A illustrates a Life Cycle Status Information coding as used in embodiments of the present invention;

FIG. 3B is exemplary of embodiments; and

FIG. 4 is a flow-chart exemplary of embodiments.

### DETAILED DESCRIPTION OF ILLUSTRATIVE EMBODIMENTS

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment. Moreover, particular conformations, structures, or characteristics may be combined in any adequate way in one or more embodiments.

The references used herein are provided merely for convenience and hence do not define the extent of protection or the scope of the embodiments.

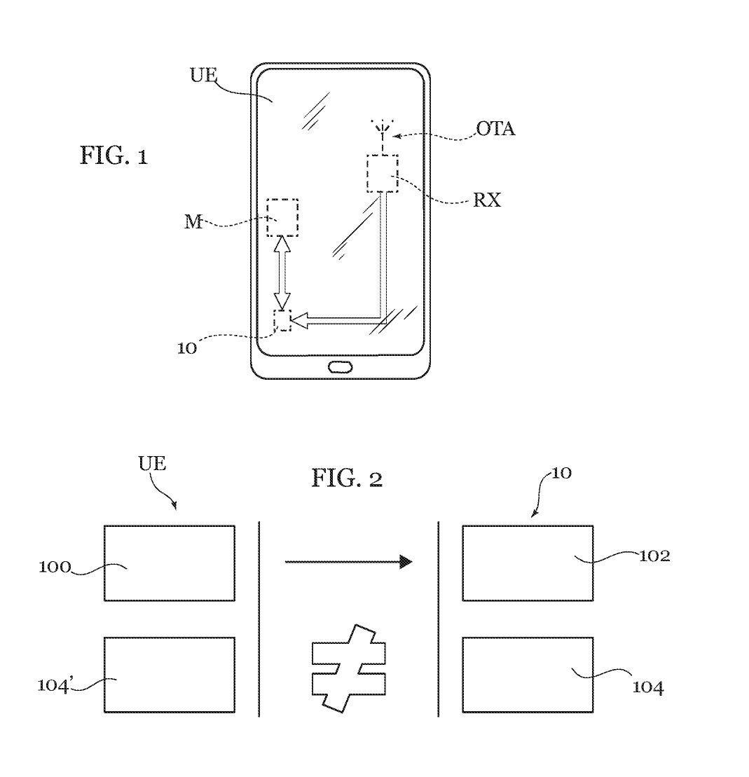

FIG. 1 is exemplary of the possibility of using an integrated circuit card (UICC or eUICC) in an apparatus such as a mobile communication equipment. A mobile terminal (User Equipment (UE)) such as a mobile phone or a tablet may be an exemplary of such an apparatus.

In one or more embodiments, the integrated circuit card functionality may be included in a so-called SIM-on-Chip, adapted to be incorporated (e.g., soldered by resorting to surface mount technology—SMT) in apparatus as exemplified in FIG. 1.

Apparatus UE is exemplified in FIG. 1 as including a card 10 such as a UICC/eUICC running an operating system and including a memory for storing a content of the card 10 such as a UICC profile. The UE may also include a receiver circuit RX configured for receiving over-the-air messages OTA such as, e.g., file update messages for the card 10 as well a memory M storing an image of the content of the card 10, e.g., UICC profile image. Such an arrangement is conventional in the art, thus making it unnecessary to provide a more detailed description herein.

In one or more embodiments the memory M and the card 10 may be configured for co-operating as discussed in the following.

FIG. 2 is exemplary of a situation which may occur when, as exemplified at 100, an over-the-air message transmitted, e.g., by a mobile network operator results in a file update 102 (say, an update of a file Y) in an integrated circuit card (e.g. UICC or eUICC) as portrayed at 10 in FIG. 1.

FIG. 2 is exemplary of the fact that such an update operation may lead to in the (e.g. Y-file) content of the integrated circuit card memory (as indicated by 104) being different from the corresponding (non-updated) Y-file content 104′ in the memory M of apparatus e.g. UE.

These two files may in fact differ insofar as the user equipment (e.g. mobile phone) reads the contents of the files in the card as a result of being turned on. If, following an (e.g. OTA) file update operation, the user equipment is not turned off, a mis-alignment may arise. This may last until the equipment is turned off and on again, which may be a few minutes to several days.

In brief, as schematically represented in FIG. 2, when an over-the-air message is dispatched by the integrated circuit card 10, mis-alignment of the contents of a notionally same file in the memory M of apparatus and the memory of integrated circuit card 10 may result.

It is observed that alignment of the apparatus memory (e.g., as used to interact with the network, the user or other peripherals) after a remote (e.g. OTA) operation on the card 10 may thus be facilitated by switching off and then again switching on the apparatus to produce a bootstrap phase. Such a bootstrap phase may include a time frame where the card content is read and loaded in the memory of the apparatus. A refresh command may then be issued from the card 10 in order to cause a renewed reading of the card content by the apparatus.

In the former case, an operator message may advise a user unaware of the update asking him or her to turn the equipment off and then on. If however the user does not perceive the sound alert (“beep”) or vibration indicative of the message or does not proceed with equipment turn off and on the former approach is ineffective and cannot solve the mis-alignment issue.

Especially the latter approach may involve loading and installing a specific application in the card (e.g. UICC/eUICC). Such an application will be in charge of a request for the apparatus to update the image of the UICC/eUICC with the newly updated values so that the user may not be exposed to any disservice or service disruption.

Certain costs may derive from “applet” development while further issues may be related to the card space for hosting and interoperability, e.g., running a same applet of cards of different suppliers/operators.

The application may adopt various options in order to manage such a refresh operation, e.g., the application may be registered e.g. in the so-called File Update Event in order to be notified by the operating system of the integrated circuit card of any change with respect to a well-defined list of files. The application may be triggered by an additional over-the-air command requesting the refresh step.

Such approaches involve application design, deployment and interfacing via over-the-air messages. Also, the latter option considered above might result in a certain increase of traffic of over-the-air commands.

To sum up, approaches are desirable which are not exposed to the risk that the equipment is not switched off and then on by the user and/or do not suffer from increased memory requirements, e.g., for storing an applet.

One or more embodiments involves exploiting so-called RFU bits (RFU being an acronym for Reserved for Future Use) in the most significant nibble of the life cycle status information (LCSI) byte, briefly referred to as status byte.

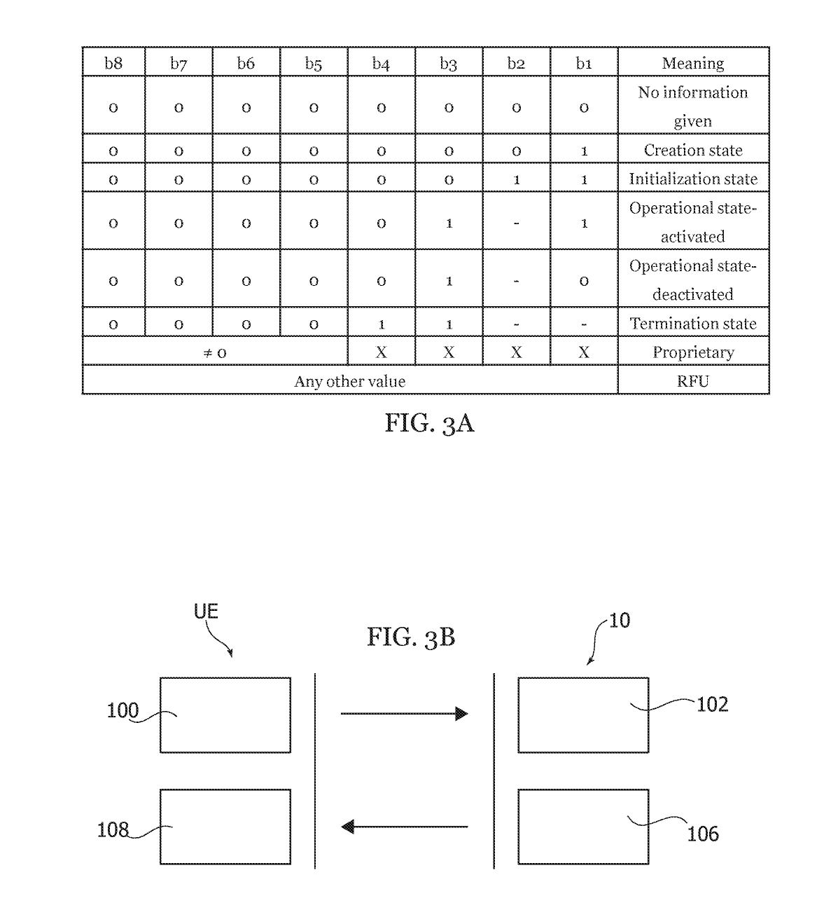

In one or more embodiments, when a new elementary file is created in the card 10 (e.g. UICC/eUICC) the data field of the Create file command may contain (e.g. in its header) an “life cycle” information item such as: 85 HEX—life cycle status information (LCSI); 01 length of LCSI; and LCSI information coded, e.g. as illustrated in the Table shown in FIG. 1A. FIG. 3A illustrates a Life Cycle Status Information (LCSI) coding as used in embodiments of the present invention.

One or more embodiments may use such RFU bits in order to create a file with an additional “refreshability” status so that, e.g., after a remote file update, the card operating system will be able to issue (automatically and autonomously) a refresh command (if a refreshability indication is set) by reading the LCSI byte. Alternately, in other embodiments, the proprietary value from the LCSI may also be used.

In that way the operating system of the card itself can manage automatically a refresh command at the end of an over-the-air update by facilitating prompt alignment of (all) the contents of the card (UICC/eUICC) files updated during the OTA session and its image as loaded in the associated apparatus.

In one or more embodiments, in the case plural files are updated with a (single) message (e.g. OTA), a single refresh command may be issued including a list of the updated files.

Such an approach is exemplified in FIG. 3B. In FIG. 3B the sequence of acts 100, 102 is as already discussed in connection with FIG. 2, and to the update of the file content in the card memory (block 104 in FIG. 2, not visible in FIG. 3) an act is associated as exemplified by block 106 where the card prompts a refresh command of the corresponding file (e.g. file Y) in the memory of apparatus UE.

As a result (block 108) the apparatus will re-read the content of the Y file in the card 10 and align its memory to that content.

In that way, as a result of an over-the-air message dispatched by the card, if a corresponding value is set in the file, the card operating system may issue refresh command so that the card memory and the memory of apparatus UE will be (immediately) aligned.

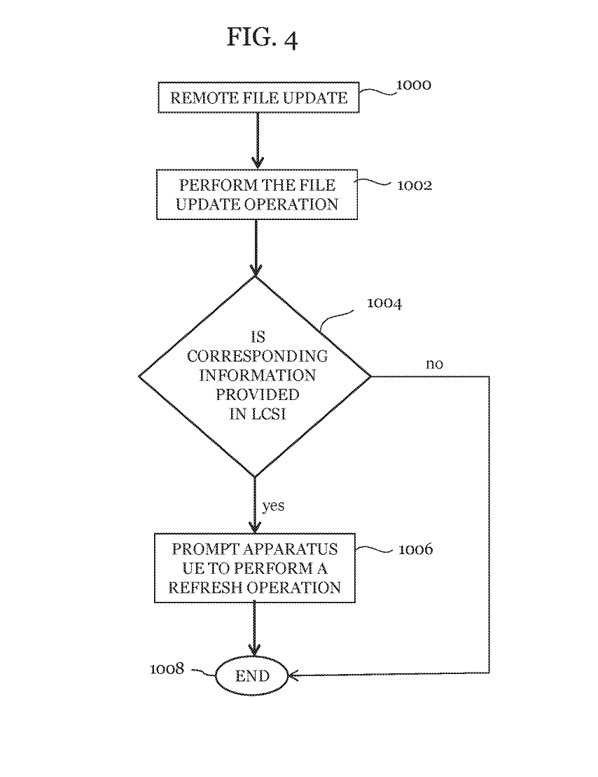

A corresponding procedure as exemplified in the flow chart of FIG. 4 may involve the following parts. Referring to step 1000, a remote file update of e.g. an elementary file, say “Y” is performed. Next, in step 1002, the operating system of the card performs the file update operation. In step 1004, a check is made as to whether corresponding information is provided in e.g. the high nibble of LCS by checking, e.g., if the high nibble of LCSI is greater than one for the Y file. In step 1006, upon determining that the check of step 1004 yielded a positive outcome, the operating system of the card will prompt apparatus UE to perform a refresh operation of the e.g. Y file in its memory. Step 1008 is an end step which may be reached after the step 1006 or as a result of a negative outcome of the step 1004.

In brief, in one or more embodiments, when a remote file update operation takes place, the operating system of the card 10 (UICC/eUICC, for example) may perform such an operation by also reading (e.g. before completing the operation) the most significant nibble of the life cycle status information (LCSI), e.g., as illustrated in FIG. 3A.

In case such a value is e.g. higher than 1, an indication is given that the file was created with a “refreshability” option so that the operating system of the card 10 may start a pro-active session by asking the apparatus UE to perform refresh file operation.

In one or more embodiments such a refresh command may be issued as a result of events such as: during a current section (e.g. the one following the latest card reset) a profile download command has been issued by the apparatus UE indicative of that apparatus being able to support such a capability as requested from the card; and no other proactive session is running.

Such an approach may facilitate compliance with standard protocols between the card 10 and the apparatus UE. In such a condition a refresh command may be requested from the apparatus UE e.g. with a mode file change modification.

Use of one or more embodiments may be detected e.g. by: reading LCSI byte issued at file select; noting that, after a remote file update, a refresh occurs on a file with LCSI set at a given value e.g. higher than 1×; no application are present at the SIM/UICC/eUICC level; and immediate alignment occurs between the card content and its image as loaded in the apparatus UE.

In one or more embodiments, a method may include: providing an integrated circuit card (e.g. 10) in mobile communication apparatus (e.g. UE) having apparatus memory (e.g. M); receiving (e.g. RX, 100, 1000) a (e.g. file) update message (e.g. OTA) at the integrated circuit card and updating (e.g. 102; 1002) the card content in compliance with the update message; issuing from the card an apparatus memory refresh command (e.g. 106, 108; 1006); and refreshing the apparatus memory to (automatically) align the apparatus memory with the updated card content.

In one or more embodiments, refreshing the apparatus memory may include the apparatus re-reading (e.g. 108) an updated card content.

One or more embodiments may include: providing in the integrated circuit card a memory location for storing life cycle status information (LCSI); and writing in said memory location command issue code producing issue of said refresh command as a result of reception of said update message.

In one or more embodiments, a command issue code may be written in the reserved for future use or RFU bytes of the memory location for the life cycle status information.

One or more embodiments may include issuing the apparatus memory refresh command as a result of: a profile download command issued by the apparatus indicating apparatus ability to support the apparatus memory refresh command from the card; and no concurrent proactive session being running.

One or more embodiments may include issuing the apparatus memory refresh command with mode file change modification.

One or more embodiments may include: receiving at the integrated circuit card a (single) update message for a plurality of files; and issuing a (single) apparatus memory refresh command including a list of the files in said plurality of files (whereby a desired alignment can be achieved for the plurality of files with a single act.

One or more embodiments may relate to an integrated circuit card, the card insertable in a mobile communication apparatus (UE) having an apparatus memory, wherein the integrated circuit card is configured for receiving update messages, updating its content in compliance with the update messages received and issuing apparatus memory refresh commands for aligning the apparatus memory with the updated card content with the method of any of one or more embodiments.

In one or more embodiments, mobile communication apparatus (e.g. UE) having an apparatus memory (e.g. M) and a card according to one or more embodiments may include a receiver (e.g. RX) configured for receiving said update messages (e.g. as over-the-air file update messages) and transferring said messages to the integrated circuit card therein.

Without prejudice to the underlying principles, the details and embodiments may vary, even significantly, with respect to what has been described by way of example only, without departing from the extent of protection. The extent of protection is defined by the annexed claims.

What is claimed is:

1. A method including:
receiving an update message at an integrated circuit card comprising card content stored in a card memory of the integrated circuit, wherein the integrated circuit card is disposed in a mobile communication apparatus comprising an apparatus memory;
updating the card content in the card memory of the integrated circuit card in compliance with the update message;
issuing from the integrated circuit card an apparatus memory refresh command; and
refreshing the apparatus memory to align the apparatus memory with the updated card content in the card memory.

2. The method of claim 1, wherein refreshing the apparatus memory includes the apparatus re-reading an updated card content.

3. The method of claim 1, further comprising:
providing in the integrated circuit card a memory location for storing life cycle status information; and
writing a command issue code in the memory location, the command issue code configured to issue the refresh command as a result of reception of the update message.

4. The method of claim 3, wherein the command issue code is written in the reserved for future use or RFU bytes of the memory location for the life cycle status information.

5. The method of claim 3, wherein the command issue code is written in the proprietary bytes of the memory location for the life cycle status information.

6. The method of claim 1, further comprising issuing the apparatus memory refresh command as a result of determining that:
a profile download command issued by the apparatus indicating apparatus ability to support the apparatus memory refresh command from the card; and
no concurrent proactive session is running.

7. The method of claim 1, further comprising issuing the apparatus memory refresh command with mode file change modification.

8. The method of claim 1, further comprising
receiving at the integrated circuit card an update message for a plurality of files; and
issuing an apparatus memory refresh command including a list of the files in the plurality of files.

9. An integrated circuit card comprising:
a card memory storing a card content and an operating system for operating the integrated circuit card and an instruction code to be executed in the integrated circuit card by the operating system, wherein the integrated circuit card is configured to be inserted in a mobile communication apparatus having an apparatus memory, wherein the instruction code when executed by the operating system is configured to
receive an update message;
update the card content in the card memory of the integrated circuit card in compliance with the update message;
issue from the integrated circuit card an apparatus memory refresh command configured to refresh the apparatus memory to align the apparatus memory with the updated card content in the card memory.

10. The apparatus of claim 9, wherein the apparatus memory refresh command comprises a command to re-read the updated card content.

11. The apparatus of claim 9, further comprising:
a memory location for storing life cycle status information in the integrated circuit card, wherein the instruction code when executed by the operating system is further configured to write a command issue code in the memory location, the command issue code being configured to issue the refresh command as a result of reception of the update message.

12. The apparatus of claim ii, wherein the command issue code is written in the reserved for future use or RFU bytes of the memory location for the life cycle status information.

13. The apparatus of claim ii, wherein the command issue code is written in the proprietary bytes of the memory location for the life cycle status information.

14. The apparatus of claim 9, wherein the instruction code when executed by the operating system is further configured to issue the apparatus memory refresh command as a result of determining that:
a profile download command issued by the apparatus indicating apparatus ability to support the apparatus memory refresh command from the card; and
no concurrent proactive session is running.

15. The apparatus of claim 9, wherein the instruction code when executed by the operating system is further configured to issue the apparatus memory refresh command with mode file change modification.

16. The apparatus of claim 9, wherein the instruction code when executed by the operating system is further configured to
receive at the integrated circuit card an update message for a plurality of files; and
issue an apparatus memory refresh command including a list of the files in the plurality of files.

17. A mobile communication apparatus comprising:
an apparatus memory;
a receiver configured to receive an update message;
an integrated circuit card comprising a card memory storing a card content, an operating system for operating the integrated circuit card, and an instruction code to be executed in the integrated circuit card by the operating system, wherein the instruction code when executed by the operating system is configured to
receive the update message from the receiver;
update the card content in the card memory of the integrated circuit card in compliance with the update message;
issue from the integrated circuit card an apparatus memory refresh command configured to refresh the apparatus memory; and
refresh the apparatus memory to align the apparatus memory with the updated card content in the card memory.

18. The mobile communication apparatus of claim 17, wherein the apparatus memory refresh command comprises a command to re-read the updated card content.

19. The mobile communication apparatus of claim 17, further comprising:
a memory location for storing life cycle status information in the integrated circuit card, wherein the instruction code when executed by the operating system is further configured to write a command issue code in the memory location, the command issue code being configured to issue the refresh command as a result of reception of the update message.

20. The mobile communication apparatus of claim 19, wherein the command issue code is written in the reserved for future use or RFU bytes of the memory location for the life cycle status information.
